(19) United States
(12) Patent Application Publication
(10) Pub. No.: US 2006/0208838 A1
(43) Pub. Date: Sep. 21, 2006

(54) Method for producing an electrical connection between an aluminum conductor and a contact element

(75) Inventors: Frank Beuscher, Wurzburg (DE); Matthias Ebert, Dettelbach (DE)

Correspondence Address: LERNER GREENBERG STEMER LLP, P O BOX 2480, HOLLYWOOD, FL, 33022-2480, US

(73) Assignee: Leoni Bordnetz-Systeme GmbH & Co. KG

(21) Appl. No.: 11/417,687

(22) Filed: May 4, 2006

Related U.S. Application Data
(63) Continuation of application No. PCT/EP04/13366, filed on Nov. 25, 2004.

(30) Foreign Application Priority Data
Dec. 4, 2003 (DE) 103 57 048.9-34

(51) Int. Cl. H01H 51/22

(52) U.S. Cl. 335/78

(57) ABSTRACT

A method for producing a reliable and permanent electrical connection between an aluminum conductor and a contact element includes melting a supply of a contact-making material and forming a cohesive material connection between the aluminum conductor and the contact element by subsequent solidification in order to form the electrical connection. In order to ensure that the functions of electrical contact-making and strain relief do not interact with one another in a disadvantageous manner, the contact element is shaped to form the mechanical strain relief, after the formation of the electrical contact.

### CROSS-REFERENCE TO RELATED APPLICATION

This is a continuing application, under 35 U.S.C. § 120, of copending International Application No. PCT/EP2004/013366, filed Nov. 25, 2004, which designated the United States; this application also claims the priority, under 35 U.S.C. § 119, of German Patent Application 103 57 048.9, filed Dec. 4, 2003; the prior applications are herewith incorporated by reference in their entirety.

### BACKGROUND OF THE INVENTION

### Field of the Invention

The invention relates to a method for producing an electrical connection between an aluminum conductor and a contact element, in which a stripped end piece of the aluminum conductor is inserted into the contact element and makes electrical contact therewith. In order to form mechanical strain relief, the aluminum conductor is clamped in the contact element by shaping the contact element.

Such a method is disclosed in both German Published, Non-Prosecuted Patent Applications DE 199 02 405 A1 and DE 33 16 563 A1. In that case, provision is made for an aluminum conductor, which is composed of a plurality of tinned braided wires, first of all to be mechanically clamped in a crimping sleeve. After the mechanical clamping, which is carried out by the shaping of the crimping sleeve, the crimping sleeve is soldered or welded to the tinned aluminum conductor.

Considerable efforts are being made to save weight, particularly in the motor vehicle field. One manner of accomplishing that purpose is the use of aluminum conductors instead of the otherwise conventionally provided copper conductors. Where aluminum or copper conductors are referred to herein, it also means that the majority of the conductors are formed from aluminum/copper or an aluminum/copper alloy. Weight saving can be achieved as a result of the considerably reduced relative density of aluminum.

Since aluminum forms an oxide layer in conjunction with the oxygen in the air, which covers the aluminum conductor and only has poor conductivity, there are problems in making contact with an aluminum conductor. When making contact between the aluminum conductor and a contact element, it is necessary, in order to ensure that the contact resistance is as low as possible, that the oxide layer be at least largely removed in the area of the contact surface between the aluminum conductor and the contact element.

### SUMMARY OF THE INVENTION

It is accordingly an object of the invention to provide a method for producing an electrical connection between an aluminum conductor and a contact element, which overcomes the hereinafore-mentioned disadvantages of the heretofore-known methods of this general type, which allows contact to be made in a manner that can be produced easily, which is reliable and which is resistant in the long term, with low contact resistance.

With the foregoing and other objects in view there is provided, in accordance with the invention, a method for producing an electrical connection between an aluminum conductor and a contact element. The method comprises inserting a stripped end piece of the aluminum conductor into the contact element and making electrical contact between the stripped end piece and the contact element. A supply of a contact-making material is provided and the contact-making material is heated at least to the vicinity of the melting temperature of the contact-making material, to produce a material connection between the stripped end piece and the contact element with the contact-making material and to form an electrical contact. The aluminum conductor is clamped in the contact element by shaping the contact element to provide mechanical strain relief, at the same time as or subsequently to the step of forming the electrical contact.

Accordingly, a stripped end piece of the aluminum conductor is inserted into the contact element, and makes electrical contact therewith. A supply of a contact-making material is provided in order to form the electrical contact, with the contact-making material being heated at least up to the region of its melting temperature, so that it is preferably in liquid form. The subsequent solidification and hardening of the contact-making material, in particular tin or a tin alloy, results in a cohesive material connection between the aluminum conductor and the contact element. In order to form the electrical contact, the aluminum conductor is thus immersed in particular in a contact-making material molten bath, which is held in the contact element. In this case, the contact-making material is heated, for example, by irradiating it with a radio-frequency field, by illuminating it with high-energy light (laser light), or else directly through the use of a flame or some other heating element.

Furthermore, during or following the formation of the electrical contact, the contact element is mechanically shaped, so that the aluminum conductor is clamped in the contact element in order to form mechanical strain relief.

The provision of the supply of liquefied contact-making material and the “immersion” of the normally tin braided wires of the aluminum conductor result in a good electrical contact between the aluminum conductor and the contact element, with a low contact resistance. In this case, the contact element is normally likewise tinned on its inner surface. A penetration depth of the contact-making material between the individual braided wires, and thus a contact surface to the braided wires, is advantageously selected in this case by the choice of the amount of contact-making material.

A further major advantage is the simultaneous or subsequent shaping of the contact element. This is because, on one hand, the heated contact-making material also heats the contact element, so that this results in shaping that is resistant to the process, without any material damage and in particular without crack formation. One particular advantage is also that the making of the contact by the formation of the cohesive material connection, which requires the heating of the contact-making material, does not take place after the shaping. This is because the heat that is required to liquefy the contact-making material would in this case, with a contact element that had already been shaped, possibly lead to relaxations in the material structure of the shaped area, thus weakening the mechanical clamping force. In particular, this would endanger the long-term resistance of the strain relief. In the case of the method described herein, the functions of the formation of the mechanical strain relief on one hand and the formation of the electrical contact on the other hand are accordingly carried out separately from one another and do not disadvantageously influence one another.

In accordance with another mode of the invention, the contact element is shaped in a shaping zone which is at a distance from a contact-making zone in which the electrical contact is made. This measure is used on one hand to separate the mechanical function from the electrical function. In particular, this is associated with the advantage that the contact-making process, which is carried out before the shaping, in particular via tin or a tin alloy, is not adversely affected by the pressure required for the shaping process being exerted. The contact-making zone is not subjected to the influence of any pressure, so that there is no risk of subsequent flowing of the contact-making material, which could cause the electrical contact to deteriorate.

In accordance with a further mode of the invention, the contact element is additionally heated in the shaping zone in order to allow shaping, while protecting the material, with a better flowing behavior than that in the case of cold shaping, and without crack formation. The contact-making material is expediently heated to a maximum of about 280° C. This measure prevents damage to any insulation on the aluminum conductor.

In accordance with an added mode of the invention, the insulation can be protected by special clamps or other protective mechanisms. Melting is reliably ensured at a temperature of 280° C. when using tin or a tin alloy, since the melting temperature of tin is about 232° C., and the melting temperature of a tin alloy with 10% zinc is 198° C.

As an alternative to the use of a tin alloy, it is, in principle, also possible to use a solder paste as the contact-making material, which is in liquid form at 280° C. However, this results in the requirement for the solder paste to have halogen-free, non-corrosive fluxes, in order to avoid subsequent corrosion of the soldered joint.

In accordance with an additional mode of the invention, at least one partial region of the stripped end piece of the aluminum conductor is tinned, in particular for the formation of the electrical contact. According to one advantageous refinement, the partial region to be tinned is shock-heated for this purpose, and is then immersed in a tin bath. In this case, this partial piece is preferably heated to about 400° C. or more. In this case, it is advantageous for the partial piece to be shock-heated in a time of less than 1 second. This rapid heating can be carried out inductively by irradiation with a radio-frequency field or by the use of a high-energy laser light. The shock heating leads to the aluminum and the oxide layer expanding differently. This results in the formation of at least microcracks in the oxide layer, into which tin penetrates during the subsequent immersion in the bath, migrating underneath the oxide layer, so that it is delaminated, and virtually the entire area of the pure aluminum is coated with the contact-making material. An inert gas atmosphere is preferably provided in order to prevent the formation of another oxide layer after the shock heating and before immersion in the bath.

In accordance with yet another mode of the invention and a second tinning embodiment, the tinning of the partial piece is carried out by ultrasound tinning in a tin bath. This means that the partial piece is immersed in a tin bath and that suitable ultrasound waves, in particular having an amplitude of more than 10 μm, are injected. Suitably constructed ultrasound generators are used for this purpose. This type of tinning makes use of the fact that the introduction of ultrasound in the tin bath results in the creation of small cavities, so-called cavitation, which intrinsically collapse explosively. This results in considerable local pressure forces, which lead to damage and delamination of the oxide layer, so that the pure aluminum is once again wetted largely over the complete area by the tin.

In accordance with yet a further mode of the invention and a third tinning embodiment, the aluminum conductor is immersed in a tin bath, and a part of the aluminum conductor is separated or cut off in the tin bath. The critical factor in this case is that the process of cutting off in the tin bath results in a “fresh” separation or cut surface, which is wetted with tin immediately and without any contact with the oxygen in the air. This measure ensures that the cut surface is completely tinned. The separating surface corresponds to the cross section in a separating direction at right angles to the longitudinal extent of the individual braided wires, so that there is no reduction in the cross-sectional area for the electrical contact surface in the contact-making area. In this case, it is expediently possible to provide for the individual braids to be cut at an angle to their longitudinal alignment, so that the cut area is larger than the cross-sectional area.

In accordance with yet an added mode of the invention, with regard to the shaping of the contact element, one preferred development provides for the shaping process to be carried out within a very short shaping time which is in the us range, in particular in the range of about 10 μs. The major advantage of such rapid shaping is that the individual braided wires in the aluminum conductor behave less like solid braided wire and in fact more like a liquid, so that the individual braided wires are baked or fused together. This effect is comparable to a projectile which passes through a metal plate at high speed. In the reference system of the projectile, the metal plate does not appear to be a solid. In fact, the projectile passes through the metal plate like a liquid.

The sudden shaping of the contact element results in the particularly advantageous capability of producing the electrical contact at the same time as the formation of the mechanical strain relief, as well. In this case, it is even advantageously possible to dispense with the use of the contact-making material and the tinning of the aluminum conductor. The principal factor in this case is once again the high speed of the shaping process and the very hiqh pressures associated with it, which lead to the oxide layer being delaminated and to.both a force-locking connection and a direct electrical contact connection between the contact element and the aluminum conductor. A force-locking connection is one which connects two elements together by force external to the elements, as opposed to a form-locking connection which is provided by the shapes of the elements themselves. This sudden shaping can be used instead of slow, conventional shaping, in conjunction with the contact-making material. Independently thereof, this sudden shaping may, however, also be used as a separate option to the formation of the connection between the contact element and the aluminum nductor with the simultaneous formation of a mechanical joint and an electrical connection.

In accordance with yet an additional mode, the invention expediently provides for the inner surface of the contact element to be roughened or structured, in order to form a good electrical contact connection. This roughening or structuring additionally damages and cuts through the oxidation layer on the aluminum conductor while the latter is being shaped and clamped, thus resulting in contact being made in the shaping area between the contact element and the aluminum conductor. In this case the inner surface of the contact element is provided, for example, with grooves or with threads, which preferably have sharp edges. These grooves or threads thus effectively cut into the individual braided wires during the shaping process. The cutting-in process at the same time results in additional mechanical strain relief. This contact can be made in addition to the contact via the contact-making material or else as an autonomous content. Particularly in the case of the autonomous refinement without the use of the contact-making material, the sudden shaping and the simultaneous formation of the electrical connection and the mechanical joint can be achieved without any problem through the use of an automated method, that is to say an automated strike of the contact element against the aluminum conductor, at very high cycle rates.

In accordance with again another mode of the invention, fast magnetic shaping is carried out by magneto-compression for the sudden shaping. In the case of magneto- compression, very high magnetic fields are produced on the contact element to be shaped so that high currents are induced in the contact element, which in turn form a magnetic field so that the contact element is repelled, and in the process shaped, on the basis of the Lorenz force. For this purpose, by way of example, the contact element is preshaped in the form of a sleeve or a slotted sleeve, into which the aluminum conductor is inserted. The externally applied magnetic field in this case leads to the sleeve being shaped radially inwardly, so that the inserted aluminum conductor is clamped. If suitable magnetic fields are chosen, the magneto-compression can result in pressures up to the region of, for example, 2000 bar. Since no mechanical shaping elements are required in this case, the contact element is not damaged, despite these high pressures.

In accordance with again a further mode of the invention and a second shaping embodiment, the sudden shaping is carried out through the use of a shaping element by mechanical impact molding. In this case, the shaping element is expediently struck at a speed of more than 5 m/s, in particular of more than 10 m/s, against the contact element. Conventional hydraulic pressures do not reach these speeds and are thus not suitable for sudden shaping. The speeds for the shaping element in this case are preferably produced just by the weight force, that is to say the shaping element (for example which is in the form of a mandrel or claw) strikes the contact element to be shaped, like a falling axe.

In accordance with a concomitant mode of the invention, the connection between the aluminum conductor and the contact element is also insulated against moisture. In this case, in particular, shrink sleeving is pulled on, or the connection is coated with an insulating varnish or insulating adhesive.

Other features which are considered as characteristic for the invention are set forth in the appended claims.

Although the invention is illustrated and described herein as embodied in a method for producing an electrical connection between an aluminum conductor and a contact element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, plan view of a connection between a contact element and an aluminum conductor;

FIG. 2 is a fragmentary, plan view of the contact element with the aluminum conductor, illustrating magneto-compression;

FIG. 3 is a fragmentary, plan view of the contact element and the aluminum conductor, illustrating shaping by impact molding; and

FIGS. 4 to 6 are flow diagrams showing examples of different method procedures.

### DESCRIPTION OF THE PREFERRED EMBODIMENTS

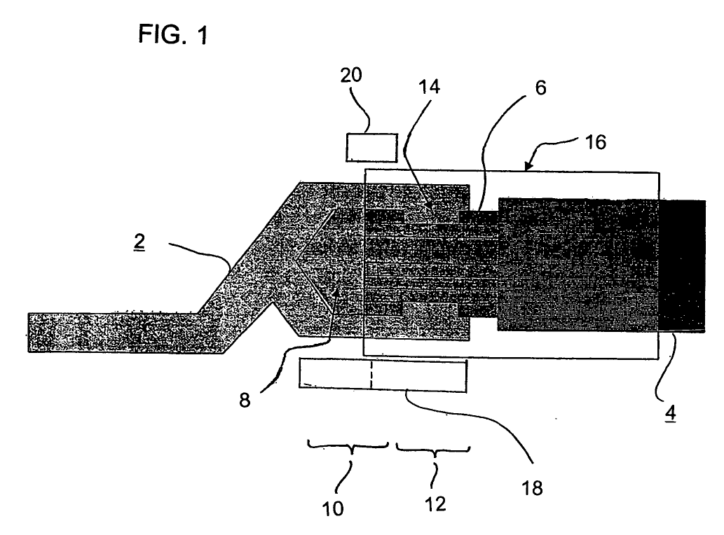

Referring now in detail to the figures of the drawings, in which parts having the same effect are provided with the same reference symbols, and first, particularly, to FIG. 1 thereof, there is seen a connection which has already been completed between a contact element 2 that is composed in particular of copper and is in the form of a cable lug, and an aluminum conductor 4. In this case, the contact element 2 is in the form of a sleeve and has a holding area into which a stripped end piece 6 (having the insulation removed) of the aluminum conductor 4 is inserted. Individual braided wires of the aluminum conductor 4 are exposed in the end piece 6. The braided wires are tinned, at least at a partial region of their end face. A supply or reservoir is provided with a contact-making material 8, in particular with tin or a tin alloy in this case, between the end-face of the braided wires and a rear wall or a base of the contact element 2. The tin alloy is used to make the electrical contact between the aluminum conductor 4 and the contact element 2. An inner surface of the contact element 2 is preferably likewise pre-tinned in this case.

In order to form the contact, the tin alloy is introduced into the contact element 2, and is melted. The aluminum conductor 4 with the stripped end piece 6 is introduced into the contact element 2 at this stage, or even before the melting process. In particular, the end-faces of the braided wires are immersed in the molten tin alloy 8. After solidification, a cohesive material connection is thus produced between the contact element 2 and the individual braided wires of the aluminum conductor 4. A contact-making zone 10 is formed in the region of the contact-making material 8 and the end-faces of the braided wires.

A shaping zone 12 is provided at a distance from the contact-making zone 10. The contact element 2 is shaped within the shaping zone 12. In this case, FIG. 1 already shows the shaped state, in which a shaped partial piece 14 of the contact element 2 has penetrated the stripped end piece 6. This measure results in the aluminum conductor 4 being clamped in the contact element 2, thus forming effective mechanical strain relief. Once the electrical connection and the mechanical joint have been formed between the contact element 2 and the aluminum conductor 4, the connecting region is also surrounded by a shrink sleeve 16, as insulation against moisture, in the exemplary embodiment.

In order to carry out the shaping process, provision is made for the contact element 2 to be heated, at least in the shaping zone 12. A heating element 18 which is provided for this purpose has two parts in the exemplary embodiment, while at the same time also being used to heat the contact-making material 8 to near its melting temperature. The heating element 18 in the exemplary embodiment is subdivided into two functional zones, which are constructed for different requirements, specifically for heating the contact-making material 8 in the supply and for heating the contact element 2. As an alternative to this, only one heating element 18 may also be provided, for heating the contact-making material 8. In this case, the contact element 2 is necessarily also heated. An ultrasound generator 20 is also provided in the exemplary embodiment shown in FIG. 1. This generator is used to provide an electrical function, through tinning of untinned braided wires by the application of ultrasound once the braided wires have been immersed in the molten supply. In this case, the contact element 2 is mechanically fixed in a suitable manner to an ultrasound probe, or is coupled for sound purposes by a transmission medium in order to transmit the required ultrasound energy.

The electrical contact making, which takes place in particular in a time sequence, and the shaping of the contact element 2, as well as the physical separation of the contact-making zone 10 from the shaping zone 12, effectively separate from one another the functions of making electrical contact on one hand and providing mechanical strain relief on the other hand. This means that these two functions do not disadvantageously influence one another. This is because the shaping that is carried out by the heating of the contact-making material 8 precludes the risk of the unshaped region of the contact element 2 being relaxed or weakened by the introduction of heat. The physical separation of the shaping zone also ensures that the solidified tin does not flow under the influence of the pressure applied during the shaping process, which can lead to undesirable weakening of the electrical contact and to an increase in the contact resistance.

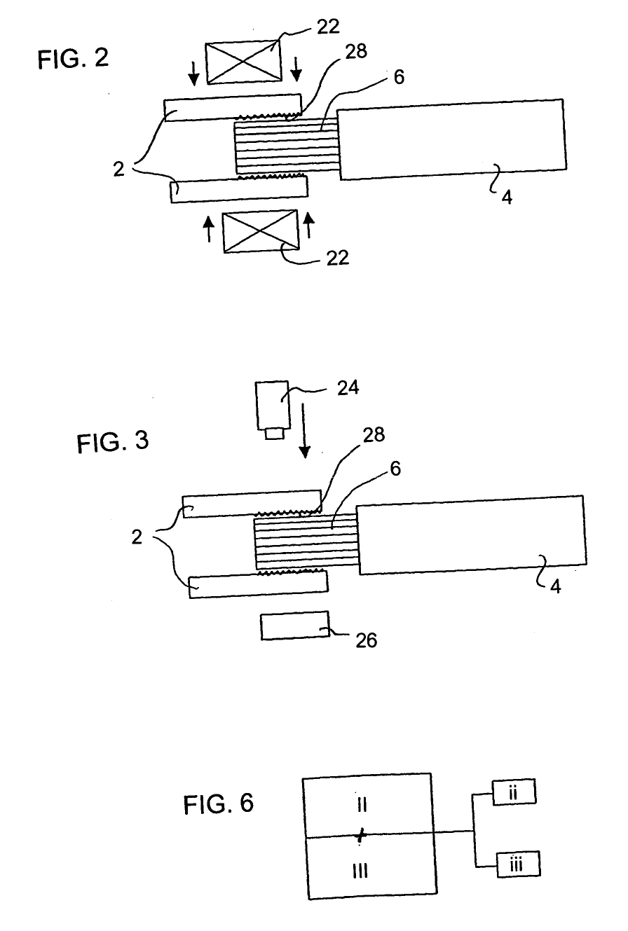

The shaping process can be carried out in a conventional manner by mechanical or hydraulic pressing of shaping elements against the contact element 2. As an alternative to this conventional shaping, shaping by magneto-compression is provided in the exemplary embodiment shown in FIG. 2. To be precise, in this case, magnet coils 22 in the immediate outer region of the contact element 2 produce a very strong magnetic field, so that currents are induced in the conductive contact element 2, and the Lorenz force is formed. This acts on the contact element 2 in the direction of the arrows illustrated in FIG. 2, thus resulting in the shaping of the contact element 2.

As an alternative to this, according to the exemplary embodiment shown in FIG. 3, so-called mechanical impact molding is provided for the shaping process. In this process, a shaping element 24 is struck against the contact element 2 at very high speed. In the exemplary embodiment, the shaping element 24 is in the form of a mandrel. An opposing element 26 is disposed on the opposite side of the contact element 2 and, in particular, can also produce the shape for the shaping process. The high speed of the shaping element 24 in the direction of the arrow shown in FIG. 3 is preferably achieved solely by acceleration as a result of gravitation. As an alternative to this, it is possible to accelerate the shaping element 24 by compressed air with the aid of a hammer mechanism, or pyrotechnically.

In the shaping processes illustrated in FIGS. 2 and 3, shaping is carried out very quickly with a time duration in the μs range. The sudden shaping achieves the particular effect of the individual braided wires being cohesively or materially-connected to one another.

The sudden shaping processes as shown in FIGS. 2 and 3 can thus be carried out in addition to the mechanical connection in order to produce the electrical contact as well, in addition to or as an alternative to the electrical contact-making via the contact-making material 8. For this purpose, the inner surface of the contact-making element 2 is roughened or structured at least in the shaping zone 12. In the exemplary embodiment, a thread 28 is cut into the sleeve-like contact element 2. FIGS. 2 and 3 show the condition before the shaping process. After the shaping process, the thread turns (which in particular have sharp edges) of the thread 28 cut into the braiding wires and in this case, in particular, cut through the oxide layer.

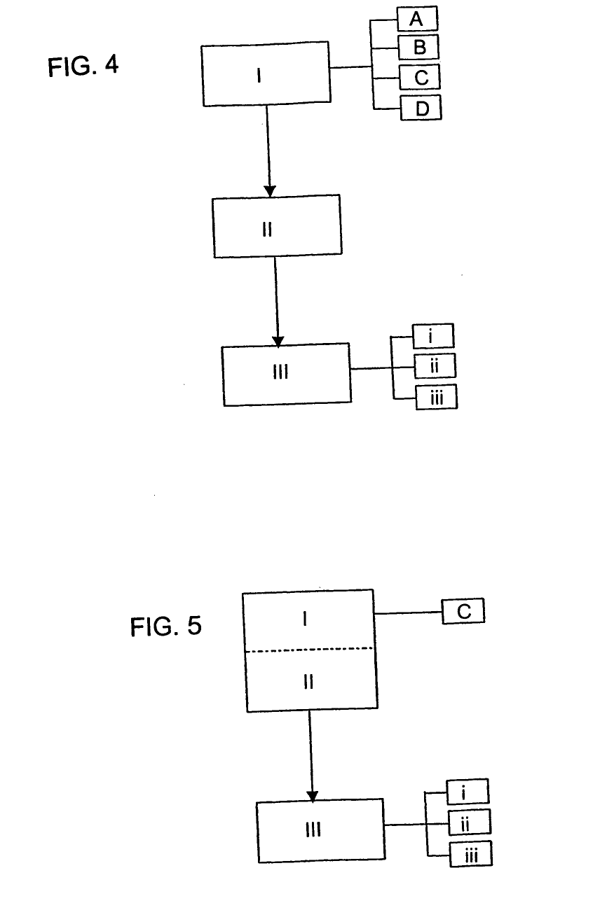

Various method variants for the formation of both the electrical connection and the mechanical joint between the contact element 2 and the aluminum conductor 4 will be explained in the following text with reference to the flow diagrams which are illustrated in FIGS. 4 to 6. In this case, the individual method steps are identified as follows:
I: tinning of the braided wires of the aluminum conductor 4;
II: making electrical contact between the aluminum conductor 4 and the contact element 2; and
III: formation of the mechanical joint/strain relief.

The method step “I: tinning of the aluminum conductor 4” can alternatively be carried out by one of the following method elements:
A: conventional tinning or use of an aluminum conductor with pre-tinned braided wires;
B: tinning by shock heating and immersion in a tin bath;
C: tinning by ultrasound treatment in a tin bath; and
D: separation or cutting of the braided wires in a tin bath.

The method step “III: formation of the strain relief” is carried out by one of the following method elements:

i: conventional shaping;

ii: shaping by magneto-compression;

iii: shaping by impact molding.

On the basis of the method procedure shown in FIG. 4, the aluminum conductor 4 is first of all pre-tinned in the stripped partial region 6 through the use of one of the method elements A, B, C or D.

The method elements B, C and D in particular are distinguished by a very good tinning result, so that these method elements can also be used independently of the making of the electrical contact between the aluminum conductor 4 and the contact element 2, as an autonomous tinning method. After the tinning process, the electrical contact is made, as has been described with reference to FIG. 1. In this case, the individual braided wires are immersed in a molten reservoir of the tin or of the tin alloy, so that a cohesive connection is formed between the individual braided wires and the contact element 2 via the tin, after solidification. The shaping process is then carried out in the method step III, in particular by using one of the methods (ii, iii) described with reference to FIG. 2 or FIG. 3.

As a modification to the method procedure shown in FIG. 4, the method steps II and III can also be carried out simultaneously, that is to say the shaping need not necessarily be carried out after the solidification of the melt. The only critical factor is that the melting process does not take place after the shaping process.

According to the method procedure shown in FIG. 5, the method steps I and III are combined with one another in a common process, that is to say they are carried out at the same time. To be precise, provision is made in this case for the tinning of the braided wires to be carried out with the aid of the ultrasound tinning based on the method element C, as has been described with reference to FIG. 1.

The method procedure shown in FIG. 6 is distinguished overall by a single-stage process, in which there is no need for the method step I, that is to say the tinning of the braided wires. The electrical contact (II) and the mechanical joint (III) are made within a single process step according to the method elements ii or iii. This single-stage method, as illustrated in FIG. 6, for the production of the electrical connection and mechanical joint, is particularly suitable for automation with a high cycle rate.

We claim:

1. A method for producing an electrical connection between an aluminum conductor and a contact element, which method comprises the following steps:
inserting a stripped end piece of the aluminum conductor into the contact element and making electrical contact between the stripped end piece and the contact element;
providing a supply of a contact-making material;
heating the contact-making material at least to the vicinity of the melting temperature of the contact-making material, to produce a material connection between the stripped end piece and the contact element with the contact-making material and to form an electrical contact; and
clamping the aluminum conductor in the contact element by shaping the contact element to provide mechanical strain relief, at the same time as or subsequently to the step of forming the electrical contact.

2. The method according to claim 1, which further comprises carrying out the step of forming the electrical contact in a contact-making zone, and carrying out the step of shaping the contact element in a shaping zone at a distance from the contact-making zone.

3. The method according to claim 2, which further comprises heating the contact element in the shaping zone.

4. The method according to claim 1, which further comprises carrying out the step of heating the contact-making material by heating the contact-making material to a maximum of about 280° C.

5. The method according to claim 1, wherein the contact-making material is selected from the group consisting of tin and a tin alloy.

6. The method according to claim 1, which further comprises tinning at least one partial region of the stripped end piece of the aluminum conductor.

7. The method according to claim 6, which further comprises shock-heating and then immersing the partial region to be tinned in a tin bath.

8. The method according to claim 7, which further comprises heating the partial region to about 400° C. or more.

9. The method according to claim 7, which further comprises carrying out the step of shock-heating the partial region in a time of less than 1 s.

10. The method according to claim 7, which further comprises carrying out the steps of shock-heating and subsequent immersion in an inert gas atmosphere.

11. The method according to claim 6, which further comprises carrying out the step of tinning the partial region by ultrasound tinning in a tin bath.

12. The method according to claim 11, which further comprises carrying out the steps of ultrasound tinning and forming the contact between the aluminum conductor and the contact element, in one process.

13. The method according to claim 6, which further comprises cutting off a part of the aluminum conductor immersed in a tin bath for tinning.

14. The method according to claim 1, which further comprises carrying out the step of shaping the contact element within a shaping time in the μs range.

15. The method according to claim 14, which further comprises roughening or structuring an inner surface of the contact element.

16. The method according to claim 14, which further comprises carrying out the shaping step by magneto-compression.

17. The method according to claim 14, which further comprises carrying out the shaping step by mechanical impact molding with a shaping element.

18. The method according to claim 17, which further comprises striking the contact element with the shaping element at a speed of more than 5 m/s.

19. The method according to claim 17, which further comprises striking the contact element with the shaping element at a speed of more than 10 m/s.

20. The method according to claim 1, which further comprises insulating the connection between the aluminum conductor and the contact element against moisture.
